(19) United States
(12) Patent Application Publication
(10) Pub. No.: US 2015/0334199 A1
(43) Pub. Date: Nov. 19, 2015

(54) METHOD ENABLING A NETWORK MONITORING SYSTEM TO NON-INTRUSIVELY ASSESS QUALITY OF USER EXPERIENCE DURING THE LOADING OF A WEBPAGE

(71) Applicant: INFOVISTA SAS, Les Ulis (FR)

(72) Inventors: Thierry Martin, Savonnieres (FR); Eric Jonot, Verezt (FR); Nicolas Neel, Artannes Sur Indre (FR); Didier Jean, Sorigny (FR)

(73) Assignee: INFOVISTA SAS, Les Ulis (FR)

(21) Appl. No.: 14/437,590

(22) PCT Filed: Sep. 23, 2013
(86) PCT No.: PCT/EP2013/069719

§ 371 Date: Apr. 22, 2015

(30) Foreign Application Priority Data
Oct. 26, 2012 (FR) 1260247

(51) Int. Cl. H04L 29/08; H04L 12/26; H04L 12/24

(52) U.S. Cl. CPC H04L 67/22; H04L 67/02; H04L 41/5003; H04L 43/106

(57) ABSTRACT

A provided method provides an assessment of quality of user experience during the loading, on a client, of a web page from a remote server via a network, according to the http protocol, the web page having a root file and at least one reference to a resource, including: a first step including identifying and timestamping the loading of a root file by the client; and a second step including: a step of identifying and timestamping the loading, by the client, of a resource assigned to the root file, a step of processing the timestamps to determine a relative load time of the resource corresponding to the period between the start time of the root file loading and the end time of the loading of the resource assigned to the root file; a step of analysis assessing the user experience in which the relative resource load time is an index.

### FIELD OF THE INVENTION

The present invention relates to a method enabling a monitoring system to determine a Key Performance Indicator (KPI) of user experience with respect to the loading of a webpage.

Measuring the load time of a webpage and more precisely the user experience is complicated by the nature of the subject being monitored. A webpage is not a monolithic unit, but a set of resources (text files, images, scripts, etc.) that are loaded asynchronously by the Internet browser. Moreover, certain technologies—for example Ajax—allow resources to be downloaded after the webpage has apparently finished loading from the user's standpoint.

In a known manner, a first approach for ascertaining the user experience consists of a “naive” analysis of the network traffic between a client and a web server. It is necessary to wait for the resource called by the last reference to be loaded, in order to assess the load time. In fact, once the page has “apparently” loaded, it is nevertheless possible that other web resources may be required. However, the user experience with respect to the load time of a webpage is linked to the time taken by the browser to load all the resources of the page in question. This analysis does not enable the user experience to be ascertained with respect to the display time of a webpage. Analysis of the exchanges (“traces”) between the client and the web server does not make it possible to reproduce the overall display time of the page from the user's standpoint.

Other known approaches are intrusive.

A first category of known intrusive approach requires code to be integrated in the webpages being monitored. As a result, only the web pages containing this code integration are monitored. This first category of known approach is the one used by Google in the product Google Analytics.

A second category of known intrusive approach requires instrumentation of a web browser of the client. For the Internet Service Provider (ISP), this second category of known intrusive approach involves implementing instrumentation of the browsers of clients. Change of browser by the client then poses a problem because the client experience during the loading of a webpage is no longer assessed.

A purpose of the invention is to propose a method for determining relevant information relating to the user experience during the loading of a webpage.

Another purpose of the invention is to propose a non-intrusive method for determining the user experience during the loading of a webpage. Another purpose of the invention is to propose a method that does not require the integration of code in the webpage to be monitored.

Another purpose of the invention is to propose a method that does not require the instrumentation of a browser of the client.

### DISCLOSURE OF THE INVENTION

This objective is achieved with a method for providing an evaluation of the experience of a user during a loading, on a client, of a webpage originating from a remote server via a network, according to the HTTP protocol, said webpage being constituted by a root file and at least one reference to a resource,

this method comprising:
a first step comprising identification and timestamping of a loading of a root file by said client,
a second step comprising:
a step of identification and timestamping of a loading, by said client, of a resource which is assigned to said root file,
a step of processing said timestamps in order to determine a relative load time of said resource corresponding to the duration between the start time of the loading of said root file and the end time of the loading of the resource;
a step of analysis in order to assess the experience of a user in which said relative load time of said resource is an indication.

Advantageously, the method according to the invention can be implemented by an IP network monitoring system comprising means for capturing frames on said network.

Preferably, the first step is implemented by the IP network monitoring system.

Preferably, the second step is implemented by the IP network monitoring system.

On the other hand, by defining a resource as an apparent end-of-page marker and by using the relative load time of a resource with respect to its webpage as defined previously, it is possible to assess the user experience.

The method according to the invention thus enables a non-intrusive web traffic monitoring system to assess the user experience during webpage browsing.

Advantageously, the identification of a resource assigned to the “root” file can comprise processing the content of the “Referer” field in the HTTP header of the resource which points to the root file. In fact, within the HTTP headers of the requests, the “Referer” field indicates the page to which the requested resource relates.

Preferably, processing of the content of the “Referer” field is implemented by the IP network monitoring system.

For the record, the content of an HTTP header is given below.

| Header name | Description |
|---|---|
| Accept | Type of content accepted by the browser (for |
| | example text/html) |
| Accept-Charset | Character set expected by the browser |
| Accept-Encoding | Data encoding accepted by the browser |
| Accept-Language | Language expected by the browser (English by |
| | default) |
| Authorization | Identification of the browser to the server |
| Content-Encoding | Type of encoding of the body of the request |
| Content-Language | Type of language of the body of the request |
| Content-Length | Length of the body of the request |
| Content-Type | Type of content of the body of the request (for |
| | example text/html) |
| Date | Data transfer start date |
| Forwarded | Used by the intermediate machines between the |
| | browser and the server |
| From | Makes it possible to specify the email address of the |
| | client |
| From | Makes it possible to specify that the document must |
| | be sent if it has been modified since a certain date |
| Link | Relation between two URLs |
| Orig-URL | URL of origin of the request |
| Referer | URL of the link from which the request was made |
| User-Agent | String giving information on the client, such as the |
| | name and version of the browser, the operating |
| | system |

In addition, the method according to the invention can be implemented for a webpage referencing at least two resources, the second step being able to be carried out for at least two of the at least two resources, the at least two relative load times of the at least two resources constituting an indication for evaluating the experience of a user.

In addition, the maximum time of the at least two relative load times can constitute an indication for evaluating the experience of a user.

The step of analysis for evaluating the experience of a user can utilize a determination of a relative load time of the last resource called by the root file.

Advantageously, the method according to the invention can be implemented in order to detect a change in the experience of at least one user during a loading, on a client, of a webpage originating from a remote server via a network, according to the HTTP protocol.

In a particular version, the method according to the invention can moreover comprise a step of storing the user's experiences over time and an analysis of the change in this experience.

In addition, the method according to the invention can moreover comprise a step for detecting an abnormal change in the relative load time on the basis of statistical data acquired during the course of earlier implementations of the method.

According to another aspect of the invention, a system is proposed for monitoring an IP network, comprising means for capturing frames on the network, implementing the method according to the invention.

In addition, the system according to the invention can be implemented in order to compare relative load times of one and the same webpage originating from a server, for a plurality of clients.

It is possible for the client not to form part of the monitoring system. The client is not affected by the implementation of the method according to the invention. That is to say that the implementation of the method is transparent for the client. Similarly, no traffic associated with the method according to the invention is generated by the client. No step associated with the method according to the invention is implemented by the client.

### DETAILED DESCRIPTION

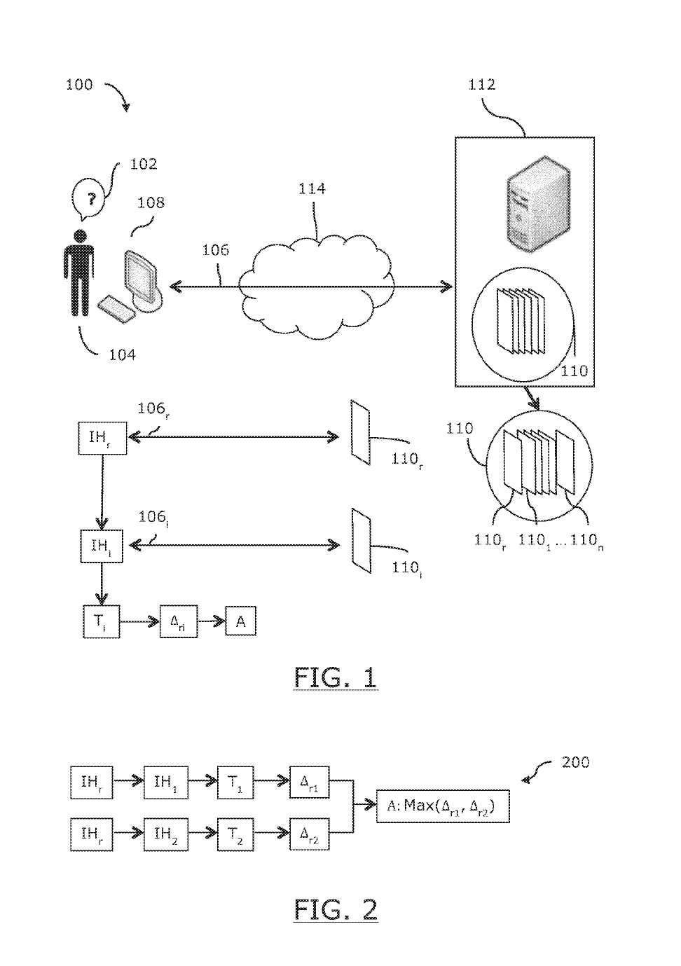

FIG. 1 shows an embodiment of the method 100 according to the invention.

The method 100 provides an evaluation of the experience 102 of a user 104 during a loading 106, on a client 108, of a webpage 110 originating from a remote server 112 via a network 114, according to the HTTP protocol. The webpage 110 is constituted by a root file 110ᵣ and n references to n resources 110₁ to 110ₙ.

A novel performance indicator associated with each resource 110ᵢ of the webpage 110 is introduced. This is the relative load time Δᵣᵢ of the resource i with respect to its webpage of reference 110. The time Δᵣᵢ is calculated as described hereinafter.

During a first step IHᵣ, a loading 106ᵣ, by the client 108, of a root file 110ᵣ is identified and timestamped. A first TCP/HTTP communication is established during the consultation of a given webpage, a (GET or POST) request is sent by the browser of the client 108 to the server 112. The latter responds by sending the root page 110ᵣ (or an appropriate HTTP return code).

During a second step IHᵢ, a loading of a resource 110ᵢ by the root file 110ᵣ is identified and timestamped. In fact, after having received the root file 110ᵣ, the browser analyses this file. The latter refers to resources 110₁ to 110ₙ. For each of the resources, the web browser of the client 108 again sends a (GET or POST) request to the server 112. A relative load time Δᵣᵢ of the referenced resource 110ᵢ corresponding to the duration between the start time of the loading 106ᵣ of the root file 110ᵣ and the end time of the loading 106ᵢ of the resource 110ᵢ by the root file 110ᵣ is determined by a processing step Tᵢ.

During a third step A an analysis is carried out in which the relative load time Δᵣᵢ of the resource is an indication which is used to assess the experience 102 of a user 104.

During the second step Tᵢ, the identification of a resource 110ᵢ by the root file 110ᵣ comprises processing the content of the “Referer” field contained in the HTTP header of the resource 110ᵢ. This “Referer” field points to the root file 110ᵣ.

FIG. 2 shows an embodiment of the method 200 according to the invention for a webpage 110 referencing three resources 110₁, 110₂, 110₃. The second step is carried out for the two resources 100₁ and 110₂. The two second steps IH₁ and IH₂ make it possible to determine two relative load times Δᵣ₁ and Δᵣ₂ of the resources 110₁ and 110₂.

In this embodiment of the method 200 according to the invention, the two relative load times Δᵣ₁ and Δᵣ₂ constitute an indication for evaluating the experience 102 of the user 104.

In another embodiment of the method according to the invention (not shown), the step of analysis for evaluating the experience of a user utilizes a determination of a relative load time Aᵣₙ of the last resource 110ₙ called by the root file 110ᵣ.

The implementation of the method according to the invention comprises a step of storing experiences 102(t) of the user over time t. It also comprises a detection of the change in the experience 102(t) of at least one user 104 during a loading, on a client 108, of a webpage 106 originating from a remote server 112 via a network 114, according to the HTTP protocol.

The method comprises a step of detecting an abnormal change in the relative load time on the basis of statistical data acquired during the course of earlier implementations of the method. An abnormal change in the load time is detected when the load time of a webpage does not fall within the usual distribution of the load times of said webpage.

In another embodiment of the method according to the invention, a system for monitoring an IP network is proposed. The system comprises probes for capturing frames on the network, implementing the method according to the invention.

Using a central processing unit, the system compares the relative load times of one and the same webpage originating from a server, for a plurality of clients.

By using the method 200 according to the invention, the central processing unit determines a relative load time, per client and for each resource of the webpages.

Then, for each pair (webpage, client), the measurements obtained per resource are aggregated in the form of minimum, maximum and average values. Of course, any other statistical indicator could be used.

Comparing these values makes it possible to highlight atypical clients and to explain the reasons for this in fine detail.

Utilization of these values by the central processing unit makes it possible, by comparison of the values, to determine if the loading of a page has taken place better overall for one client than for another. It also makes it possible, for an equivalent average value and by comparison of the maximum values, to determine if one or more of the resources in particular are at the origin of a poor load time. In such a case, the utilization makes it possible to determine the resource or resources involved.

Certain requests can be sent by the client asynchronously (for example, requests of the Ajax type). The asynchronous requests are identifiable via a specific field of the HTTP header (xmlhttprequest). These HTTP requests are either excluded in the calculations of aggregate values or filtered before aggregation. An example of filtering consists of keeping only the first request.

Of course, the invention is not limited to the examples which have just been described and numerous adjustments can be made to these examples without exceeding the scope of the invention.

1. A method implemented by a system for monitoring an IP network comprising means for capturing frames on said network, in order to provide an evaluation of the experience of a user during a loading, on a client, of a webpage originating from a remote server ia a network, according to the HTTP protocol,
said webpage being constituted by a root file and at least one reference to a resource,
said method comprising:
a first step comprising identification and timestamping, by said system for monitoring an IP network, of a loading of a root file by said client;
a second step implemented by said system for monitoring an IP network comprising:
a step of identification and timestamping of a loading, by said client, of a resource which is assigned to said root file;
a step of processing said timestamps in order to determine a relative load time of said at least one resource corresponding to the period between the start time of the loading of said root file and the end time of the loading of said at least one resource assigned to said root file; and
a step of analysis implemented by said system for monitoring the IP network for evaluating the experience of a user in which said relative load time of said resource is an indication.

2. The method according to claim 1, characterized in that the identification of a resource assigned to the root file comprises a processing, by the system for monitoring the IP network, of the content of the “Referer” field in the HTTP header of said resource which points to said root file.

3. The method according to claim 1, implemented for a webpage produced on the basis of at least two resources, characterized in that the second step is carried out for at least two of said at least two resources, the at least two relative load times of said at least two resources constituting an indication for evaluating the experience of a user.

4. The method according to claim 3, characterized in that the maximum time from said at least two relative load times (Δᵣ₁; Δᵣ₂) constitutes an indication for evaluating the experience of a user.

5. The method according to claim 1, characterized in that the step of analysis (A) for evaluating the experience of a user utilizes a determination of a relative load time (Δᵣₙ) of the last resource called by the root file.

6. The method according to claim 1, characterized in that it is implemented for detecting a change in the experience of at least one user during a loading, on a client (108), of a webpage originating from a remote server via a network, according to the HTTP protocol.

7. The method according to claim 6, characterized in that it comprises moreover a step of storing the experiences of the user over time and an analysis of the change in this experience.

8. The method according to claim 1, characterized in that it comprises moreover a step for detecting an abnormal change in the relative load time on the basis of statistical data acquired during the course of earlier implementations of said method.

9. A system for monitoring an IP network, comprising means for capturing frames on said network, implementing the method according to claim 1.

10. The system according to claim 9, implemented for comparing relative load times of one and the same webpage originating from a server, for a plurality of clients.
